(19) United States
(12) Patent Application Publication
(10) Pub. No.: US 2026/0074899 A1
(43) Pub. Date: Mar. 12, 2026

(54) Subnetwork Authentication and Mobility

(71) Applicant: Apple Inc., Cupertino, CA (US)

(72) Inventors: Dimitrios Alanis, Munich (DE); Sameh M. Eldessoki, Munich (DE); Christian Hofmann, Munich (DE); Panagiotis Botsinis, Munich (DE); Tarik Tabet, Carlsbad, CA (US)

(73) Assignee: Apple Inc., Cupertino, CA (US)

(21) Appl. No.: 18/980,391

(22) Filed: Dec. 13, 2024

(30) Foreign Application Priority Data
Sep. 6, 2024 (GR) 20240100614

(51) Int. Cl. H04L 9/08

(52) U.S. Cl. CPC H04L 9/088

(57) ABSTRACT

Techniques are described herein for subnetwork selection. An example method can include processing, by a management node (MN) of a subnetwork, a connection establishment request for a user equipment (UE) to join the subnetwork. The process can further include processing, by the MN, cryptographic information based on the connection establishment request. The process can further include authenticating, by the MN, the UE based on the cryptographic information.

### CROSS-REFERENCES TO RELATED APPLICATIONS

This application claims priority to Greek Patent Application No. 20240100614, filed on Sep. 6, 2024, which is incorporated by reference in its entirety for all purposes.

### BACKGROUND

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 illustrates an example network environment, in accordance with some embodiments.

FIG. 2 is an illustration of an example authentication process, according to one or more embodiments.

FIG. 3 is an illustration of an example authentication process, according to one or more embodiments.

FIG. 4 is an illustration of an example authentication process, according to one or more embodiments.

FIG. 5 is an illustration of an example authentication process, according to one or more embodiments.

FIG. 6 is an illustration of an example subnetwork reselection, according to one or more embodiments.

FIG. 7 is an illustration of an example subnetwork reselection, according to one or more embodiments.

FIG. 8 is an illustration of an example, internal MN selection process, according to one or more embodiments.

FIG. 9 is an illustration of an example process for MN-assisted subnetwork mobility, according to one or more embodiments.

FIG. 10 is a process for subnetwork selection, according to one or more embodiments.

FIG. 11 is a process for subnetwork selection, according to one or more embodiments.

FIG. 12 is an illustration of an example of a user equipment (UE), in accordance with some embodiments.

FIG. 13 is an illustration of an example of a network node, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device, apparatus, circuitry, or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, or 6G. In general, 3GPP access refers to various types of cellular access technologies.

The term “Non-3GPP Access” refers to any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted.” Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

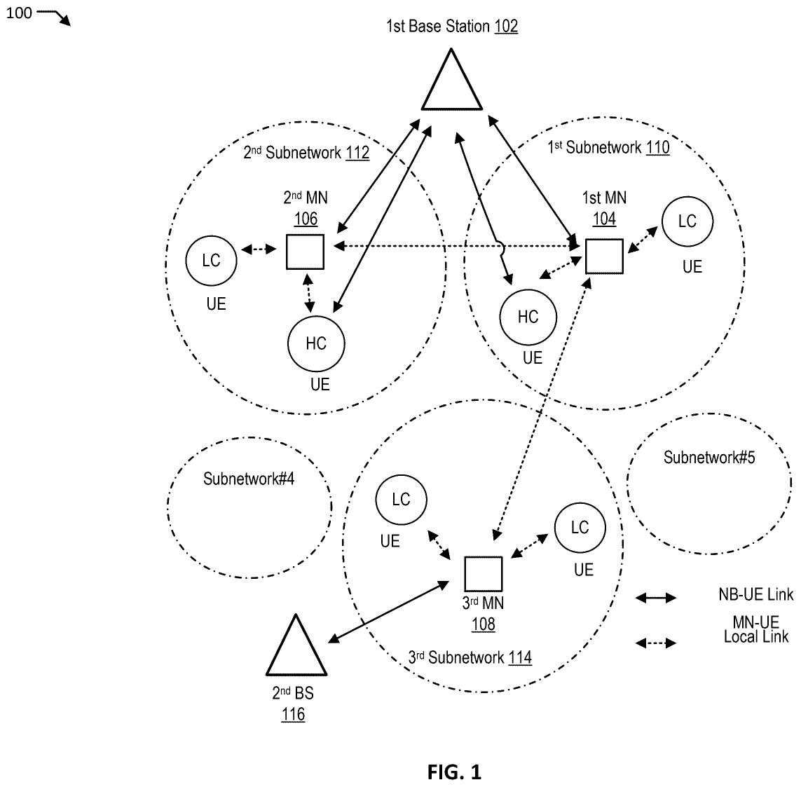

FIG. 1 illustrates an example network environment 100, in accordance with some embodiments. The network environment 100 can include a first base station 102 that provides one or more serving cells through which user equipments (UEs) may communicate with a cellular network. The base station 102 can be part of a radio access network (RAN) that is coupled with a core network (CN). The UEs and the first base station 102 can communicate over air interfaces compatible with various standards, such as Fifth Generation (5G), Sixth Generation (6G), system standards as provided by 3GPP technical specifications. The network environment 100 can include one or more management nodes (MNs) (e.g., first MN 104, second MN 106, and third MN 108) that are communicatively coupled with a base station. For example, the MN 104 can be a UE that provides a coordination role within a subnetwork (e.g., 1^{st} subnetwork 110, second subnetwork 112, and third subnetwork 114). Each MN can be a high capability (HC) device, such that the MN can establish and support a connection to the network on its own. Each MN can include, for example, a smartphone, laptop, or other HC device. Each MN may or may not be connected to the network, each MN can connect to the network via a physical random access channel (PRACH) procedure and receive paging messages. Each MN can communicate with local devices, such as the UEs. Each MN can provide or support the connection of devices to an overlay network. Each MN can be capable of establishing a link with a neighboring MN in a device-to-device (D2D) manner. For example, the first MN 104 can establish a link with neighboring third MN 108.

Each subnetwork can be described as a network that includes one or more MNs and a number of UEs that are coupled with one of the MNs. Each subnetwork node may or may not have access with an overlay base station (e.g., first base station 102, second base station 116). Each of the UEs can directly connect with the MNs or with the overlay BS via a physical connection. A physical connection, as used herein, can refer to a direct wireless connection between two devices at a physical layer of a network protocol stack. A virtual connection as used herein, may refer to a logical link between two devices. This logical link can include connections at layers above the physical layer of the network protocol stack. Each of the UEs can be an HC device or a low-capability (LC) device. An LC device can establish a connection to the network using a leaner protocol stack than the HC device. The LC device may also be a regular device with service requirements that cannot be met by the network without additional support from another device (e.g., bad channel conditions, mobility, augmented reality (AR)/virtual reality (VR), ultra-reliable low latency communications (URLLC), or other service conditions).

Each MN can form a subnetwork for the UEs without (or with limited) configuration or awareness by a base station (e.g., first base station 102, second base station 116). A base station can communicate with the MN via a physical connection and may communicate with the UEs of the subnetwork logically over virtual connections. In some embodiments, the subnetwork topology and mobility within the subnetwork may be transparent to the broader network (e.g., first base station 102, second base station 116). The MN may control various aspects of the subnetwork including, for example, routing and resource management. The MN can provide the quality of service (QoS) that provides a reliable end-to-end (E2E) link. This may be enabled by utilizing a fair scheduling mechanism across all UEs of a subnetwork and with respect to other UEs of the network environment.

A subnetwork (e.g., first subnetwork 110, second subnetwork 112, or third subnetwork 114) can be controlled by the MN (e.g., first MN 104, second MN 106, or third MN 108) independent from a broader network (for example, a RAN controlled by the first base station 102 or the CN). For example, the subnetwork may utilize a technology independent from the RAN technology. The subnetwork may use licensed or unlicensed spectrum, resources of which are granted, scheduled, or otherwise controlled by the MN independent from direct control by the base station (e.g., first base station 102, second base station 116).

In some instances, a UE may be associated with the broader network. For example, a UE of the subnetwork can remain registered with the broader network and have some aspects managed by the base station. For example, the base station can include a UE context and may control resources and mobility decisions with respect to the broader network (e.g., such as a handover between base stations of a cellular network).

In some instances, a UE may want to join a subnetwork. To do so, the MN may need to authenticate the UE. For UE to UE authentication (e.g., first MN 104 authenticating the third UE 118 or the first MN 104 authenticating the fourth UE 120), conventional systems can include a requirement that the CN control the authentication process and that the CN's servers (e.g., proximity services (ProSe) server) process the authentication. This can result in an increased workload on the CN's servers. The embodiments herein address this issue by providing techniques for the UE to control the authentication process and can optionally use the CN's servers. By doing so, the techniques can result in a reduced network load, due to reduced network interaction. The techniques can also reduce the network's complexity, as the network may not need to deploy the ProSe servers, providing more subnetwork independence. As described herein, the authentication of the UE can be performed using pre-shared keys (e.g., cryptographic keys), authentication with assistance from a base station, and authentication via an application layer (e.g., leveraging a third-party applications authentication services).

The embodiments herein also provide techniques for subnetwork selection. As described below, the techniques described herein introduce a set of capabilities exchange mechanism to assist with subnetwork selection. Additionally, the techniques can include enabling a UE to perform a subnetwork selection based on its own capabilities. The techniques also describe a flexible HO procedure that can be initiated by either a UE or an MN.

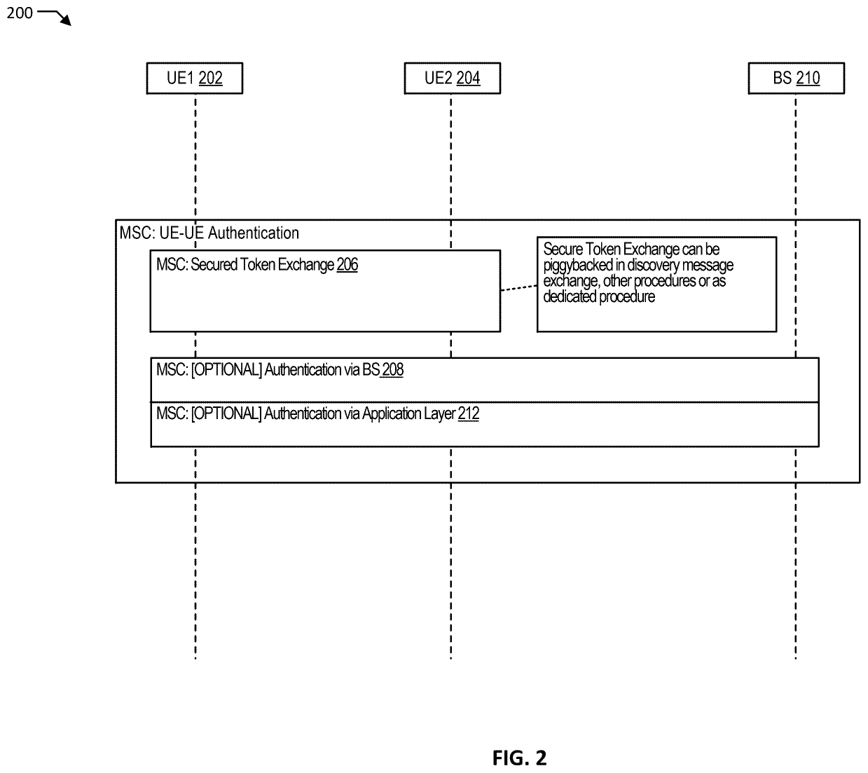

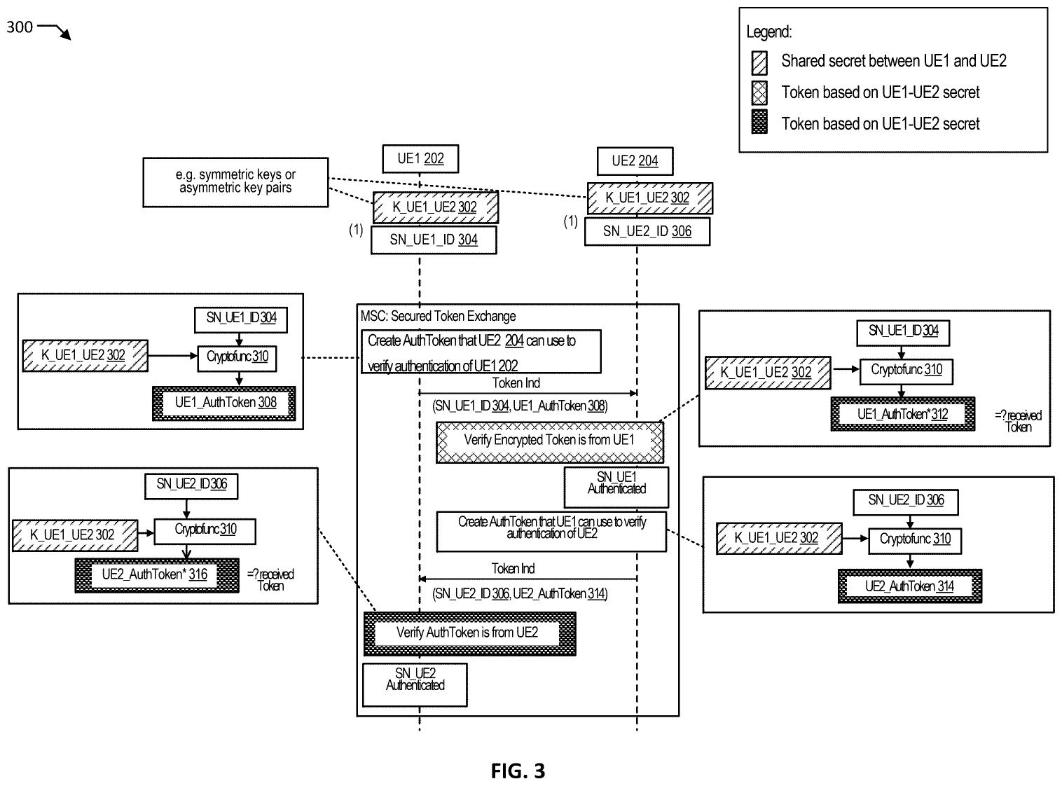

FIG. 2-6 are illustrations of example signaling diagrams for the above-described authentication techniques. FIG. 2 is an example signaling diagram 200 for UE authentication by a key exchange, base station assistance, or application layer assistance. As indicated above, a first UE 202 may want to join a subnetwork, in which the second UE 204 can act as an MN (e.g., first MN 104, second MN 106, or third MN 108) and have formed a subnetwork (e.g., first MN 104, second MN 106, or third MN 108). The first UE 202 and the second UE 204 may need to trust each other's identity for the first UE 202 to join the subnetwork. The UEs can engage in an authentication process to establish the trust in each other's identity. The authentication process can be a general process that can be effectuated by a dedicated message exchange or incorporated as part of another process (e.g., the authentication information can be embedded in subnetwork discovery messages for a discovery process or other appropriate processes). The below three procedures are described as standalone processes. As indicated above, the UE to UE authentication can occur via a secured token exchange 206. The UEs may have been previously paired and have shared keys (e.g., cryptographic keys via near field communication (NFC), a wireless personal area network, an ultra-wideband (UWB) connection, a non-terrestrial network (NTN), or a wireless local area network). In this embodiment, the UE can exchange the previously shared keys to authenticate each other's identities. This embodiment is described with more particularity with respect to FIG. 3.

In another embodiment, the authentication can be via a base station 208. The first UE 202 and the second UE 204 can receive assistance from a base station 210 (e.g., the first base station 102 or the second base station 116) for authentication. For these embodiments, both UEs can be registered to a network, such that the network has authenticated the UEs identity.

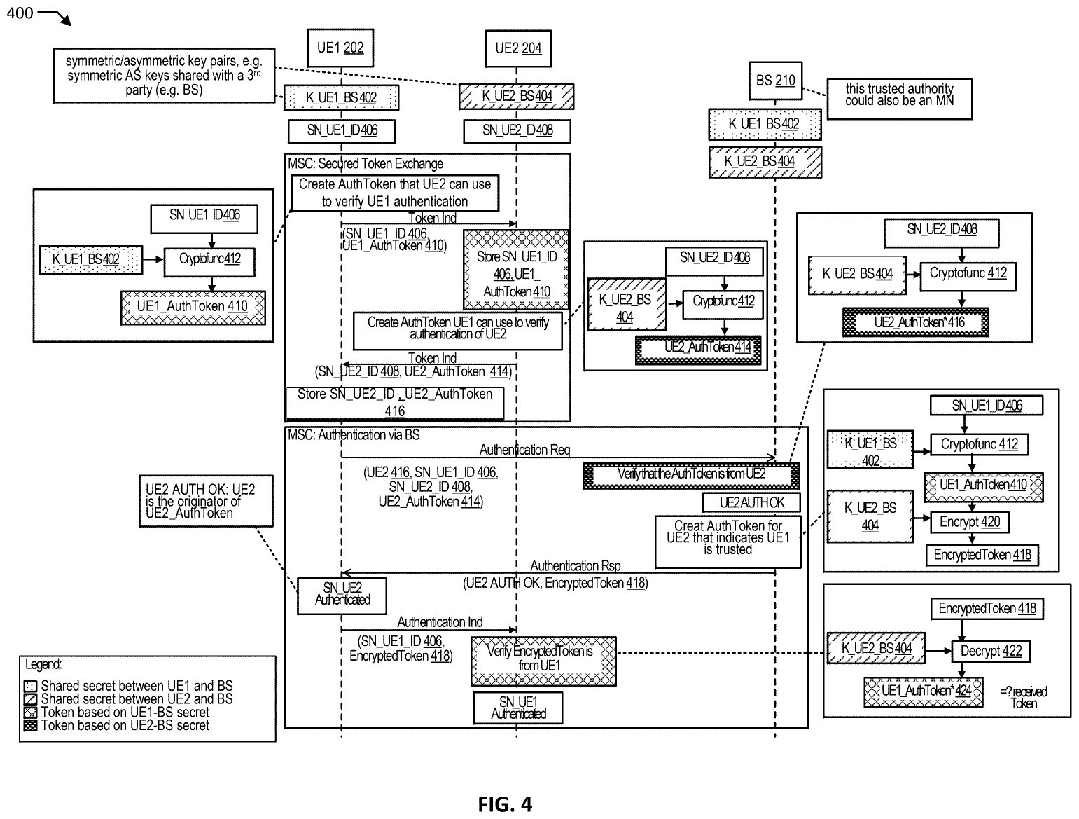

Furthermore, a base station can be configured with the access stratum (AS) security context information for both UEs and can act as the authentication authority to enable mutual authentication. The base station can reuse the AS exchange keys for establishing a RAN-like security between the UEs in order enable the first UE 202 to join the subnetwork. In this embodiment only one of the UEs may communicate with the network. It should be appreciated that although the network can provide authentication assistance, the network is not controlling the authentication process. Rather the UEs still control the authentication process. This embodiment is described with more particularity with respect to FIG. 4.

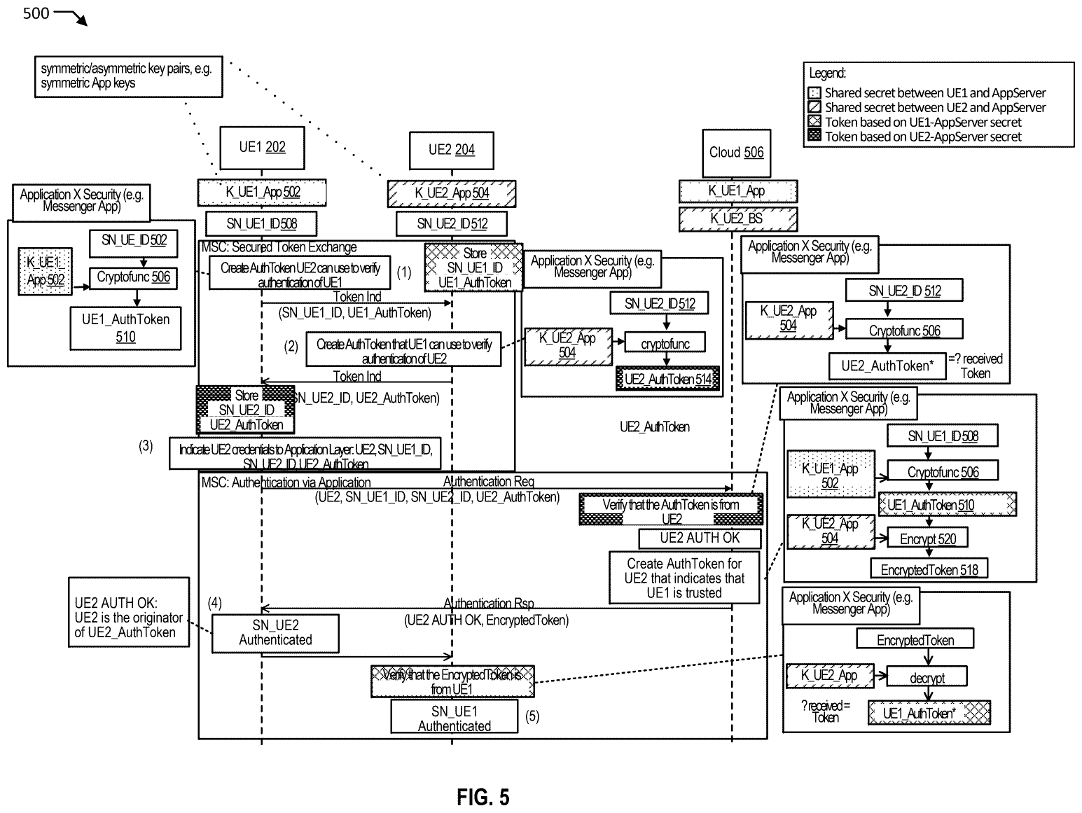

In another embodiment, the authentication can be via an application layer 212. The UEs can establish trust with each other by contacting a service from the cloud in the application layer to perform the authentication process. For example, both UEs can have previously been registered with a service (e.g., messaging application, social media application, or other service) that performs its own authentication of the UEs. The first UE 202 and the second UE can rely on the application for authenticating each other's identities. It should be appreciated that although the service can provide authentication assistance, the service is not controlling the authentication process. Rather the UEs still control the authentication process. This embodiment is described with more particularity with respect to FIG. 5.

FIG. 3 is an illustration of an example authentication process 300, according to one or more embodiments. This process involves authentication by the UEs based on previously shared keys. The first UE 202 and the second UE 204 can each have stored a key 302 (e.g., illustrated as K_UE1_UE2) from a previous session, or have previously each exchanged the key 302 or exchanged information for each to generate the key 302.

In furtherance of a request to join a subnetwork, the first UE 202 can further generate a first subnetwork specific UE identifier (ID) 304 (e.g., illustrated as SN_UE1_ID). In response to the request to the join the subnetwork, the second UE 204 can generate a second subnetwork specific UE ID 306 (e.g., illustrated as SN_UE2_ID). The first UE 202 can use the key 302 and the first subnetwork specific UE ID 304 to generate a first token 308 (e.g., illustrated as UE1_AuthToken). As illustrated, the first UE 202 can access an instance of a cryptographic function 310 from memory and provide as inputs the key 302 and the first subnetwork specific UE ID 304 to generate the first token 308. The first UE 202 can transmit the first token 308 and the first subnetwork specific UE ID 304 to the second UE 204.

The second UE 204 can process the key 302 and the first subnetwork specific UE ID 304 to generate a second token 312 (e.g., illustrated as UE1_Authtoken*). As illustrated, the second UE 204 can access another instance of the cryptographic function 310 from memory and provide the key 302 and the first subnetwork specific UE ID 304 as inputs to generate the second token 312. The second UE 204 can then compare the first token 308 and the second token 312 to determine whether they are matching tokens. If the tokens do not match, the authentication can fail. If the tokens match, the second UE 204 can authenticate the identity of the first UE 202 and generate a third token 314 (e.g., illustrated as UE2_AuthToken 314) for the first UE 202 to use to authenticate the second UE 204.

As illustrated, the second UE 204 can access the instance of the cryptographic function 310 from memory and provide the key 302 and the second subnetwork specific UE ID 306 as inputs to generate the third token 314. The second UE 204 can then transmit the second subnetwork specific UE ID 306 and the third token 314 to the first UE 202.

The first UE 202 can process the key 302 and the second subnetwork specific UE ID 306 to generate a fourth token 316 (e.g., illustrated as UE2_Authtoken*). As illustrated, the first UE 202 can access the cryptographic function 310 from memory and provide the key 302 and the second subnetwork specific UE ID 304 as inputs to generate the fourth token 314. The first UE 204 can then compare the third token 314 and the fourth token 316 to determine whether they are matching tokens. If the tokens do not match, the authentication can fail. If the tokens match, the first UE 202 can authenticate the identity of the second UE 204

FIG. 4 is an illustration of an example authentication process 400, according to one or more embodiments. As indicated above, in some instances, the authentication process can be assisted by a base station. In these instances, the first UE 202 may have registered with a network and have had its first UE security context including a first key 402 (e.g., illustrated as K_UE1_BS) stored at the base station 210. The second UE 204 may have also registered with the network and have had its second UE security context including a second key 404 (e.g., illustrated as K_UE2_BS) stored at the base station 210. Furthermore, each of the UE may have shared their respective global ID with the base station 210.

In furtherance of a request to join a subnetwork, the first UE 202 can generate a first subnetwork specific UE ID 406 (e.g., illustrated as SN_UE1_ID). In response to the request to join the subnetwork, the second UE 204 can generate a second subnetwork specific UE ID 408 (e.g., illustrated as SN_UE2_ID).

The first UE 202 can use the first key 402 and the first subnetwork specific UE ID 406 to generate a first token 410 (e.g., illustrated as UE1_AuthToken). For example, as illustrated, the first UE 202 can access an instance of a cryptographic function 412 and provide the first key 402 and the first subnetwork specific UE ID 406 as inputs to generate the first token 410. The cryptographic function 412 may or may not be the same as the cryptographic function 310 of FIG. 3. The first UE 202 can then transmit the first subnetwork specific UE ID 406 and the first token 410 to the second UE 204.

The second UE 204 can then store the first token 410 in memory. The second UE 204 can use the second key 404 and the second subnetwork specific UE ID 408 to generate a second token 414 (e.g., illustrated as UE2_AuthToken). For example, as illustrated, the second UE 204 can access another instance of the cryptographic function 412 and provide the first key 402 and the first subnetwork specific UE ID 406 as inputs to generate the second token 414. The second UE 204 can then transmit the second subnetwork specific UE ID 408 and the second token 414 to the first UE 202.

The first UE 202 can then transmit an authentication request to the base station 210 that includes the second UE's global ID 416 (e.g., illustrated as UE2), the second subnetwork specific UE ID 408, the first subnetwork specific UE ID 406, and the second token 414 to the base station 210.

The base station 210 can verify the second UEs authentication based on generating a third token using the second UE's global ID 416 to identify the second key 404. For example, the base station 210 can use the global ID 416 as a pointer to a memory address for the second key 404. For example, as illustrated, the base station 210 can access an instance of the cryptographic function 412 and provide the second key 404 and the second subnetwork specific UE ID 408 as inputs to generate a third token 416 (e.g., illustrated as UE2-AuthToken*). The base station 210 can then compare the second token 414 and the third token 416 to determine whether they are matching tokens. If the tokens do not match, the authentication can fail. If the tokens match, the base station 210 can verify the authentication of the second UE 204 and generate a fourth token 418 (e.g., illustrated as encrypted token) for the first UE 202 to use to authenticate the second UE 204. As illustrated, the base station 210 can access the cryptographic function 412 and provide the first subnetwork specific UE ID 406 and first key 402 as input to generate the first token 410. The base station 210 may use the second key 404 to encrypt the first token 410 as inputs for an encryption function 420 and generate the fourth token 418.

The base station 210 can then transmit an authentication response that includes an indication of the second UE's verification and the fourth token to the first UE 202.

The first UE 202 can process the authentication response and verify the identity of the second UE 204. The first UE 202 can then transmit the first subnetwork specific UE ID 406 and the fourth token 418 to the second UE 204.

The second UE 204 can decrypt the fourth token 418 to authenticate the identity of the first UE 202. As illustrated, the second UE can access a decryption function 422 and provide the fourth token 418 and the second key 404 as inputs to decrypt the fourth token and generate a fifth token 424 (e.g., illustrated as UE1_AuthToken*). The second UE 204 can then compare the fifth token 424 and the first token 410 to determine whether they are matching tokens. If the tokens do not match, the authentication can fail. If the tokens match, the second UE 204 can verify the authentication of the first UE 202.

FIG. 5 is an illustration of an example authentication process 500, according to one or more embodiments. As indicated above, in some instances, the authentication process can be assisted by an application. In this instances, the first UE 202 and the second UE 204 may have registered with an application and have had their security context information including a first key 502 (e.g., illustrated as K_UE1_App) and a second key 504 (e.g., illustrated as K_UE2_App) stored on the cloud 506.

The process for application assisted authentication is similar to the base station assisted authentication described in FIG. 4. One difference is that instead of using cellular security information for authentication, the process described in FIG. 5 can rely on an application layer security (e.g., on specific third party applications such as WhatsApp).

The process described in FIG. 5 can require new interfaces between the communication stack and the application layer to exchange the security credential (e.g., subnetwork specific UE IDs, received authentication tokens) as the verification is performed at the application layer and the first UE 202 and the second UE 204 can exchange information at the lower layers.

There are some differences between the process described in FIG. 5 and the process described in FIG. 4. For example, the first UE 202 can access a cryptographic function 506 and provide the first subnetwork specific ID 506 and the first key 502 as inputs to generate a first token 510 (e.g., illustrated as UE1_AuthToken). Additionally, the second UE 204 can access the cryptographic function 506 and provide the second subnetwork specific UE ID 512 and second key 504 as inputs to generate a second token 514 (e.g., illustrated as UE2_Authtoken). The second UE 204 can then transmit the second token to the application. The application can then access the cryptographic function 506 and provide the second subnetwork specific UE ID 512 and the second key 504 to generate the third token 516 (e.g., illustrated as UE2_Authtoken*). The application can then compare the second token 514 and the third token 516 to determine whether they are matching tokens. If the tokens do not match, the authentication can fail. If the tokens match, the application can authenticate the identity of the second UE 202 and generate a fourth token 518 (e.g., illustrated as encrypted token) for the first UE 202 to use to authenticate the second UE 204. As illustrated, the application can access the cryptographic function 506 and provide the first subnetwork specific UE ID 508 and first key 502 as inputs to generate the first token 410. The application can then use the second key 504 to encrypt the first token 510 as inputs for an encryption function 520 and generate the fourth token 518. The second UE 204 can then authenticate the first UE 202 similarity as described with respect to FIG. 4.

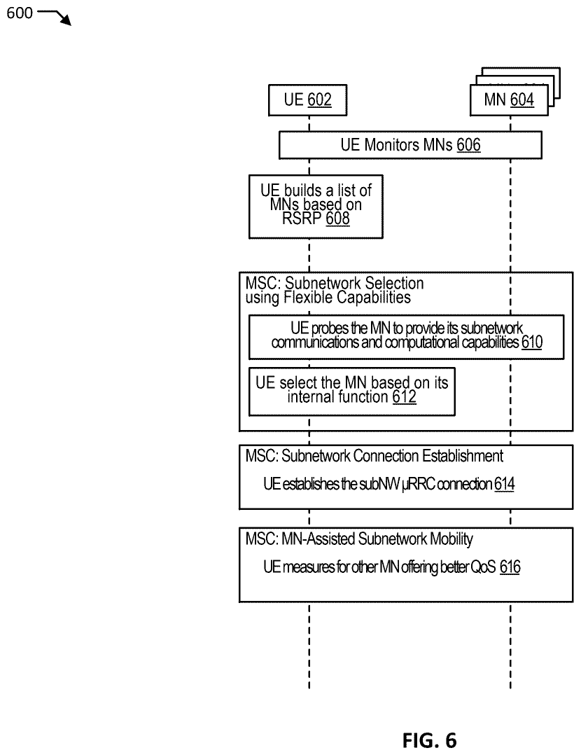

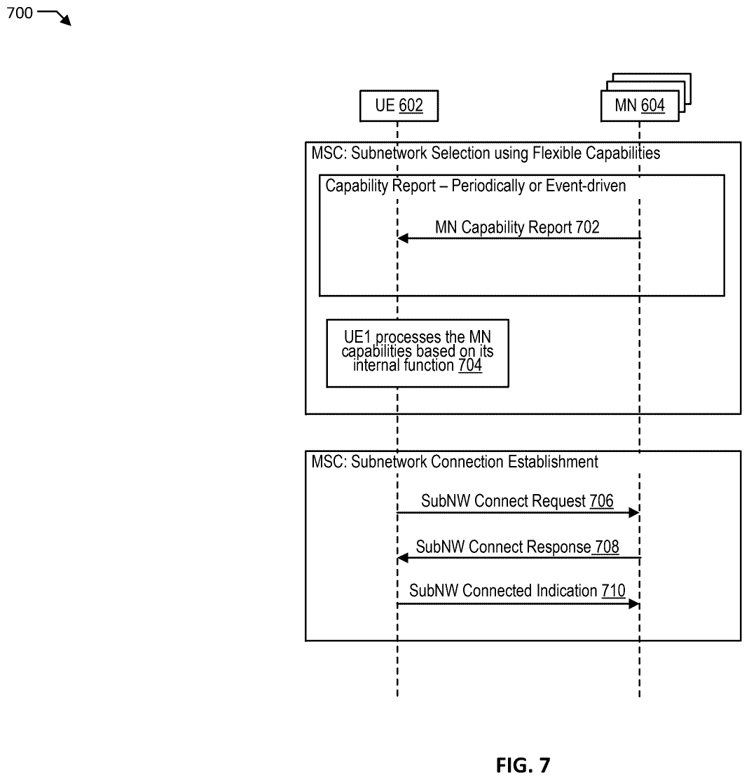

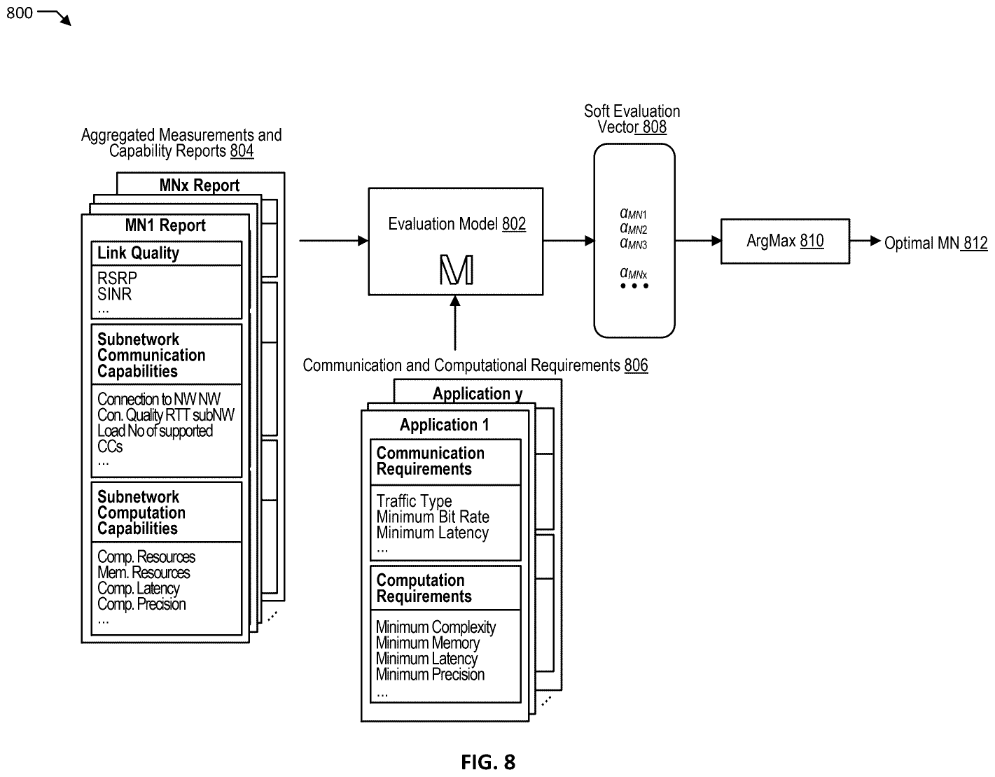

As indicated above, in addition to authentication, the techniques described herein can be used for subnetwork reselection. FIGS. 6, 7, 8, and 9 describe various aspects of subnetwork reselection. FIG. 6 is an illustration 600 of an example subnetwork reselection, according to one or more embodiments. A UE 602 can want to connect to a subnetwork and can monitor the MNs 604 that are managing the subnetworks at 606. The UE 602 can further store a list of the MNs 604 in memory at 608. The list can be based on a reference signal received power (RSRP) for each MN. The UE 602 can engage in subnetwork selection using flexible capabilities. At 610, the UE 602 can probe an MN to provide its subnetwork communications and computational capabilities. For example, the UE can monitor for system information blocks (SIBs) that are broadcast by neighboring MNs 604 and which contain their respective subnetwork capabilities. At 512, the UE 602 can use its internal function select an MN for a reselection process. At 614, the UE can establish a subnetwork RRC connection (referred to as a “μRRC connection”) with the MN. A μRRC connection can be leaner version of the RRC connection of an overlay 6G network, and can be used for subnetwork control. This process is described with more particularity with respect to FIGS. 7 and 8.

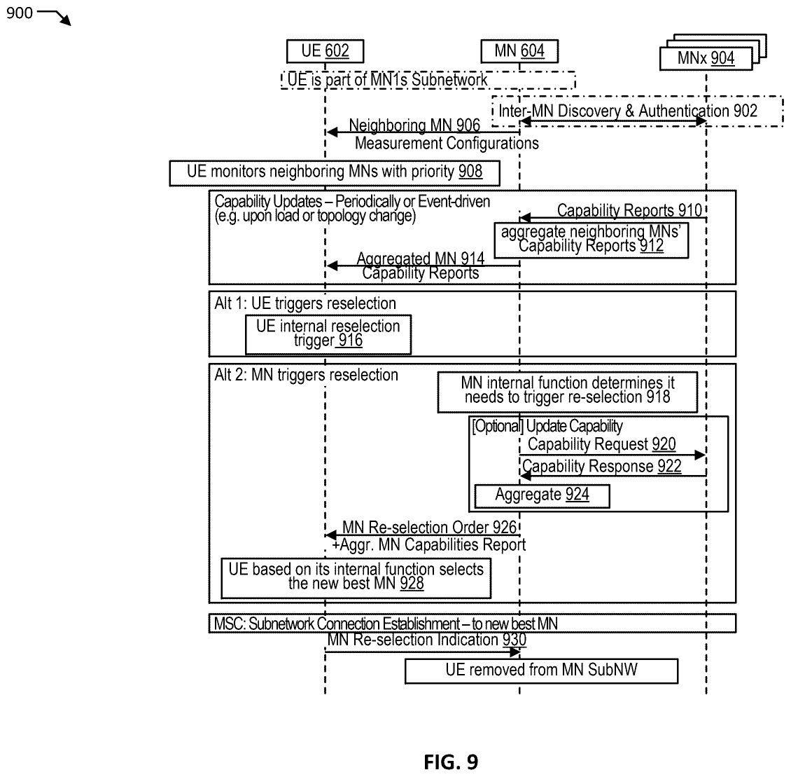

The UE can also engage in a MN-assisted reselection process. An MN can configure the UE 602 with a measurement configuration to monitor for reference signals of neighboring MNs. At 616, the UE 602 can use the configuration to measure the references signals from the neighboring MNs for better quality of service (QoS). The MN can also aggregate capability reports from the neighboring MNs. The MN can transmit the aggregated reports to each of the UEs in its subnetwork. The transmissions can be aperiodic or periodic. During an inter-subnetwork HO, the MN can also assist with the authentication between the UE and a target MN by assuming the role of the base station as described above. This process is described with more particularity with respect to FIG. 9.

FIG. 7 is an illustration 700 of an example subnetwork reselection, according to one or more embodiments. A UE 602 can process the MN's master information block (MIB) or SIB that carry the MNs subnetwork capabilities. In some instances, the UE 602 can monitor for periodic or event-driven SIBs from the MNs that contain each MN's subnetwork capabilities. As an example, at 702, an MN 604 can communicate its capabilities via a report. In some instances, the MN 604 MN 604 can communicate new subnetwork capabilities via the report. The new capabilities can include subnetwork communication capabilities and subnetwork computation capabilities. The subnetwork communication capabilities can include: connection to an overlay network (e.g., connected, local-only), connection quality to the overlay network quantified in round trip time (RTT) classes (e.g., 3 ms, 10 ms, 30 ms, and 100 ms); subnetwork load (e.g., low, medium, high, and very high), and number of component carriers (CCs) supported (e.g., low, medium, high, and very high). The subnetwork computation capabilities can include minimum complexity in floating point operations per second (FLOPS), minimum memory, minimum latency, minimum computations precision (e.g., fixed-point, float, double or other computational precision

At 704, the UE 602 process the MN capabilities based on its internal functions. For example, the UE 602 can use RSRP power measurements and the subnetwork capabilities as inotus for an internal subnetwork selection function based on the UEs communication and computation requirements to determine which subnetwork to select. For example, the UE 602 can consider a deployment option (e.g., local or with access to overlay network), communication requirements (e.g., estimated rate, latency, and jitter), and computational requirements (e.g., functional offloading and capability extension).

At 706, the UE 602 can, based on the determination, transmit a subnetwork connection request (e.g., via a μRRC protocol) to join the subnetwork. If the MN 604 accepts the request the MN 604 can transmit a subnetwork connect response at 708. At 710, upon μRRC configuration, the UE 602 can respond with a subnetwork connection indication. The UE 602 can then access the overlay network using an RRC establishment process.

FIG. 8 is an illustration 800 of an example, internal MN selection process, according to one or more embodiments. A UE (e.g., UE 602) can be configured with an internal selection process to select the best MN. Each UE can be configured with an evaluation model 802. The evaluation model 802 can be, for example, deterministic (e.g., water filing method), heuristic (e.g., stochastic gradient descent-based algorithm, or a deep neural network (DNN)). The evaluation model can be trained or configured offline, or updated online using reinforcement learning techniques.

The evaluation model 802 can process as an input aggregated measurement and capability reports 804 that include measurement and capability reports from each target MN. Each measurement and capability report can include a link quality report, characterizing the link between the between the target MN and the UEs. Each measurement and capability report can also include a target subnetwork communication capabilities report, and a target subnetwork computational capabilities report.

The evaluation model 802 can process as an input a set of application requirements that include communication and computations requirements 806. The set of application requirements can act as restraints for the evaluation model 802. Each application can be characterized by communication requirements (e.g., traffic type, minimum bit rate, minimum latency, etc.) Each application can also be characterized by computational requirements (e.g., minimum complexity in FLOPS, minimum memory, minimum latency, minimum computations precision (e.g., fixed-point, float, double or other computational precision). The evaluation model 892 can output a soft evaluation vector 808 that can be processed by a function 810 (e.g., arguments of the maxima function (ArgMax)), which can output an identity of the optimal MN 812.

FIG. 9 is an illustration 900 of an example process for MN-assisted subnetwork mobility, according to one or more embodiments. The UE 602 can be connected with an MNs (e.g. MN 604) subnetwork. At 902, the MN 604 and the neighboring management nodes (MNx) 904 can engage in inter-MN discovery and authentication. For example, the MNs (e.g., MN 604 and MNx 904) can determine measurement information and authenticate one another. At 906, the MN 604 can transmit the MNx measurement information to the UE 602. These MNx 904 can be preferred by the MN 604 as they have already authenticated and trusted by the MN. The MNx can also satisfy some minimum QoS criteria. At 908, the UE 602 can process the measurement information and perform its own measurements of the MNx 904.

The MN 604 and the MNx 904 can form an overlay subnetwork, where each MN can provide capability reports to the other MNs at 910. At 912, the MN 604 can aggregate the capability reports at 912 and transmit the aggregated capability reports to the UE 602 at 914. The MN can collect the capabilities of the MNx 904, or even down-select the capabilities according to UE's needs into the capability reports. The MN 604 can transmit the capability reports to the UE 602 periodically or upon an event, such as a change to a UE in the subnetwork in either a dedicated manner or a broadcast manner. This can assist with power-saving for the UE 602 compared to individual UEs collecting MN capabilities. It should be appreciated that MN capabilities can change due to the dynamic nature of the topology, which can justify a periodic or event-driven trigger for transmitting the MN capabilities reports.

As indicated above, the reselection process can be triggered by the UE 602 or the MN 604 and both options are described in FIG. 9. As to UE triggered reselection, the UE can be triggered based on layer three measurements, UE application, functional requirements, or indicated capability reports of the MN 604 and MNx 904. The UE 602 can then use an evaluation model to select an optimal MN.

As to the MN-triggered reselection, at 918, the MN 604 can use an internal function to determine to trigger reselection. For example, based on functional (e.g., low power level, reduced computational and communication resources for managing the subnetwork) and application requirements, the MN 604 can determine to stop acting as the MN for the subnetwork. The MN 604 can use MN reports from the MNx 904 that it has previously collected. Or, the MN 604 can transmit a capabilities request at 920 based on determining to trigger reselection. The MN 604 can receive capabilities reports from the MNx 904 at 922, and aggregate those reports at 924.

At 926, the MN 604 can transmit a reselection order to the UE 602, which can indicate that the UE 602 is to find a new MN. This can be aided by the new capabilities reports received at 922. At 928, the UE 602 can use its own layer three measurements of the MNx 904, its own application, functional requirements, or indicated capability reports to select the desired MN and connect with the selected MN and subnetwork. At 930, the UE 602 can transmit a reselection indication to the MN 604. At 932, the MN 604 can update its internal state and capabilities based on the UE 602 being removed from the subnetwork. It should be appreciated that an alternative to the MN-assisted reselection process (e.g., when losing a connection to the MN 604) can be that the UE 602 can enter into a radio link failure (RLF) mode and perform an internal selection as described with respect to FIG. 8.

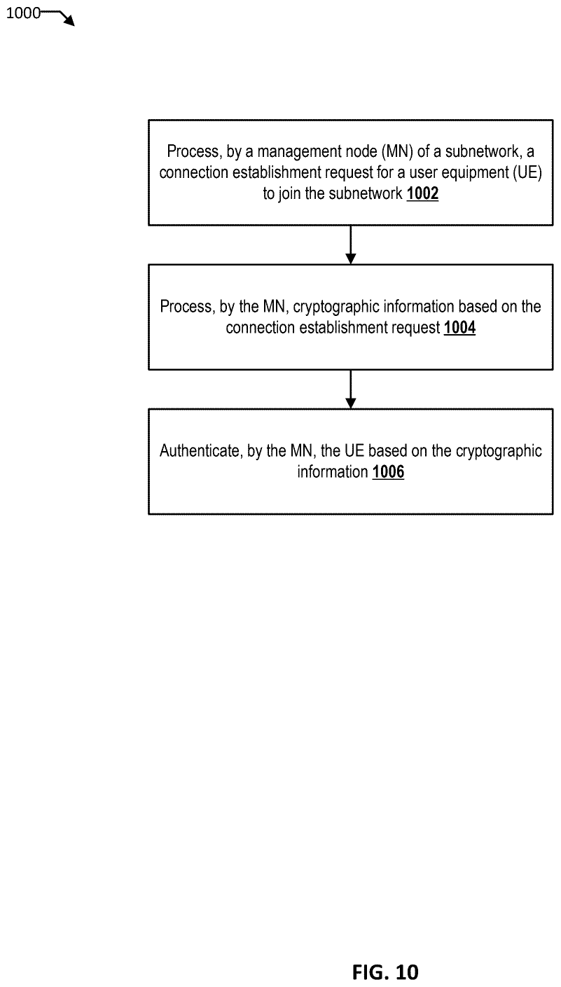

FIG. 10 is a process 1000 for subnetwork selection, according to one or more embodiments. At 1002, the process 1000 can include an MN (e.g., UE2 204) of a subnetwork processing a connection establishment request for a UE (UE1 202) to join the subnetwork.

At 1004, the process 1000 can include the MN processing cryptographic information based on the connection establishment request. For example, the MN can generate a first subnetwork ID. The MN can generate, using a cryptographic key shared with the UE, a first authentication token based on the first subnetwork ID. The MN can cause transmission of the first authentication token to the UE. The MN can process a second authentication token from the UE. The second authentication token can be generated based on transmitting the first authentication token to the UE and a second subnetwork ID. The cryptographic information can include the first authentication token and the second authentication token.

At 1006, the process 1000 can include the MN authenticating the UE based on the cryptographic information. The UE can then join the MN's subnetwork.

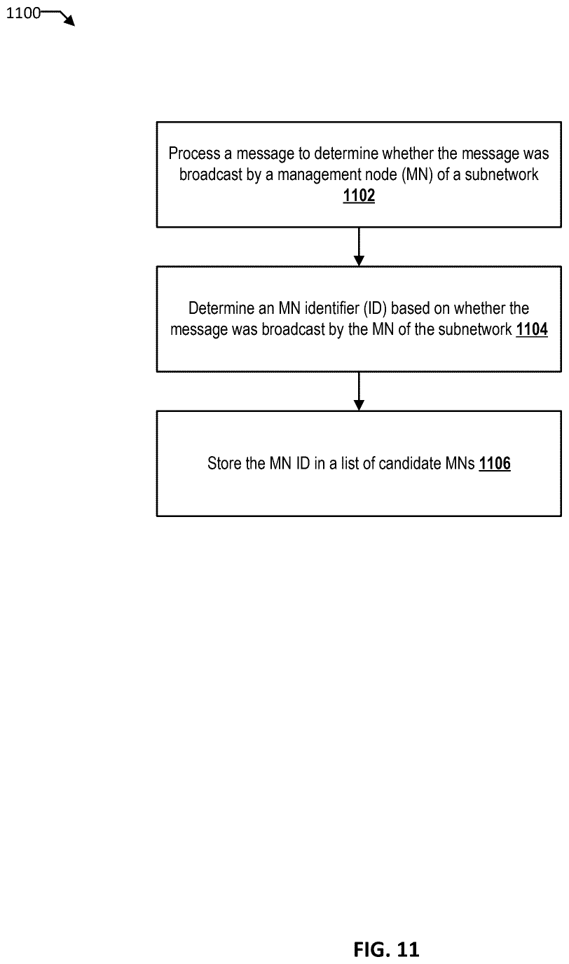

FIG. 11 is a process 1100 for subnetwork selection, according to one or more embodiments. At 1102, the process can include the UE (e.g., UE 1) processing a message to determine whether the message was broadcast by an (MN (e.g., UE 2 204) of a subnetwork. The message can include various capabilities reports for a set of MNs.

At 1104, the process 1100 can include the UE determining an MN ID based on whether the message was broadcast by the MN of the subnetwork.

At 1106, the process can store the MN ID in a list of candidate MNs. In the event that a reselection process is triggered, the UE can use the list to determine a desired MN with which to connect.

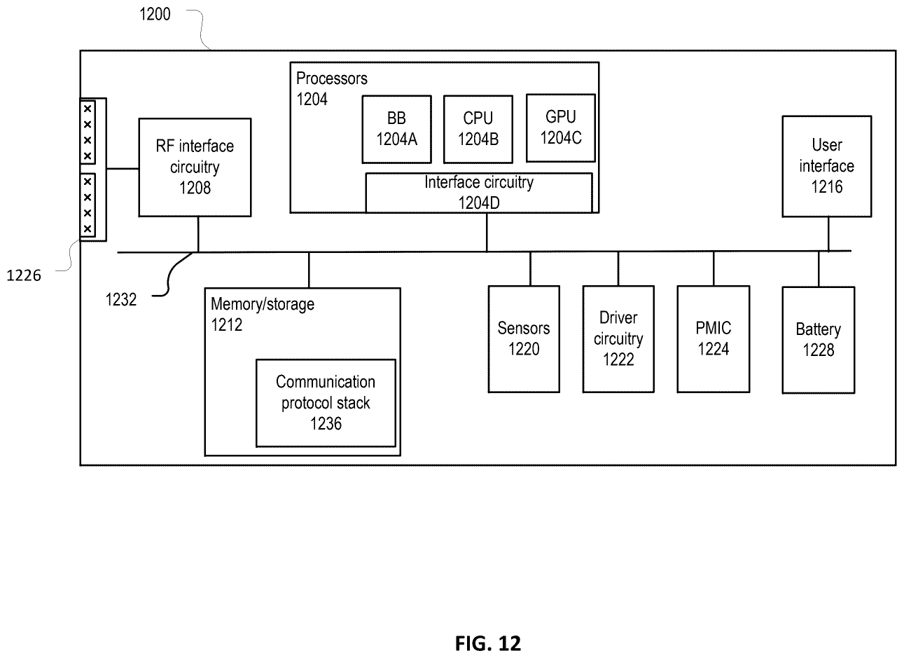

FIG. 12 illustrates a UE 1200, in accordance with some embodiments. The UE 1200 may be similar to and substantially interchangeable with a UE of FIG. 1.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform delay-adaptive operations as described herein. The processors 1204 may also include interface circuitry 1204D to communicatively couple the processor circuitry with one or more other components of the UE 1200.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack 1236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various delay-adaptive operations described herein.

The memory/storage 1212 includes any type of volatile or non-volatile memory that may be distributed throughout the UE 1200. In some embodiments, some of the memory/storage 1212 may be located on the processors 1204 themselves (for example, memory/storage 1212 may be part of a chipset that corresponds to the baseband processor circuitry 1204A), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensors 1220 and control and allow access to sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

A battery 1228 may power the UE 1200, although in some examples the UE 1200 may be mounted deployed in a fixed location and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

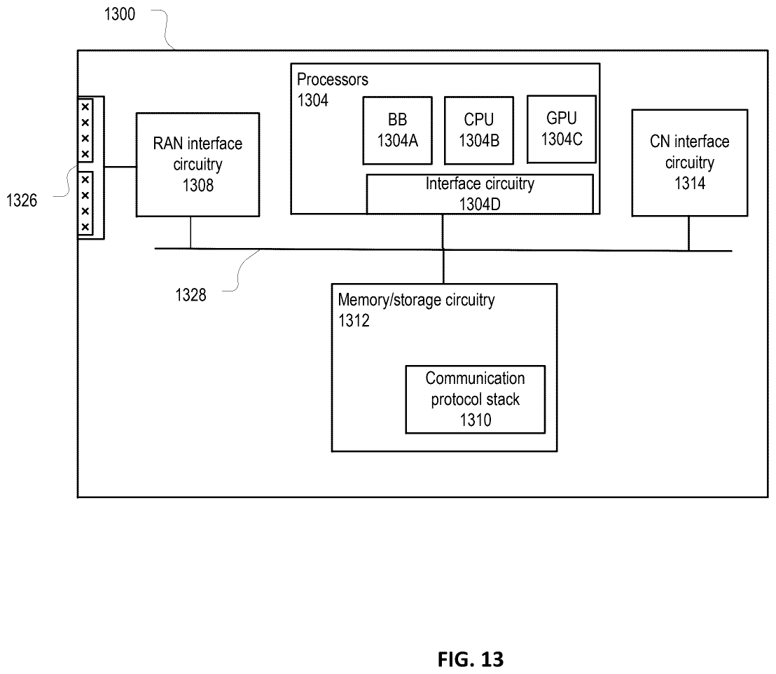

FIG. 13 illustrates a network device 1300 in accordance with some embodiments. The network device 1300 may be similar to and substantially interchangeable with base station 108 or a device of the core network or an external data network.

The network device 1300 may include processors 1304, RF interface circuitry 1308 (if implemented as a base station), core network (CN) interface circuitry 1314, memory/storage circuitry 1312, and antenna structure 1326.

The components of the network device 1300 may be coupled with various other components over one or more interconnects 1328.

The processors 1304, RF interface circuitry 1308, memory/storage circuitry 1312 (including communication protocol stack 1310), antenna structure 1326, and interconnects 1328 may be similar to like-named elements shown and described with respect to FIG. 12.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage circuitry 1312 to cause the UE 1300 to perform delay-adaptive operations as described herein. The processors 1304 may also include interface circuitry 1304D to communicatively couple the processor circuitry with one or more other components of the network device 1300.

The CN interface circuitry 1314 may provide connectivity to a core network, for example, a 5th Generation Core network (5GC) using a 5GC-compatible network interface protocol such as carrier Ethernet protocols, or some other suitable protocol. Network connectivity may be provided to/from the network device 1300 via a fiber optic or wireless backhaul. The CN interface circuitry 1314 may include one or more dedicated processors or FPGAs to communicate using one or more of the aforementioned protocols. In some implementations, the CN interface circuitry 1314 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further example embodiments are provided.
Example 1 can include a method comprising: processing, by a management node (MN) of a subnetwork, a connection establishment request for a user equipment (UE) to join the subnetwork; processing, by the MN, cryptographic information based on the connection establishment request; and authenticating, by the MN, the UE based on the cryptographic information.
Example 2 can include the method of example 1, wherein the cryptographic information includes shared key information and the method further comprises: obtaining the shared key information in a first pairing of the MN and the UE, wherein the connection establishment request is associated with a second pairing of the MN and the UE that occurs after the first pairing.
Example 3 can include the method of any of examples 1 or 2, wherein the cryptographic information is received via a discovery message exchange.
Example 4 can include the method of any of examples 1-3, wherein processing the cryptographic information comprises: generating a first subnetwork identifier (ID); generating, using a cryptographic key shared with the UE, a first authentication token based on the first subnetwork ID; causing transmission of the first authentication token to the UE; and processing a second authentication token from the UE, wherein the second authentication token is generated based on transmitting the first authentication token to the UE and a second subnetwork ID, and wherein the cryptographic information comprises the first authentication token and the second authentication token.
Example 5 can include the method of any of examples 1-4, wherein the MN and the UE are connected to a network, and wherein exchanging the cryptographic information is via a base station.
Example 6 can include the method of any of examples 1-5, wherein exchanging cryptographic information subnetwork comprises: processing a UE authentication token and a UE subnetwork ID; causing transmission of the UE authentication token, a UE subnetwork ID, a UE global ID, and an MN subnetwork ID to a base station; processing an authentication response from the base station, wherein the authentication response comprises a base station authentication token generated based on the UE global ID, wherein the cryptographic information comprises the UE authentication token.
Example 7 can include the method of any of examples 1-6, wherein exchanging the cryptographic information comprises: registering with a third-party application; processing a UE authentication token and a UE subnetwork ID; causing transmission of the UE authentication token, a UE subnetwork ID, a UE global ID, and an MN subnetwork identifier to the third-party application; and processing an authentication response from the third-party application, wherein the authentication response comprises a third-party application authentication token generated based on the UE global ID, and wherein the cryptographic information comprises the UE authentication token.
Example 8 can include an apparatus comprising: processing circuitry to: perform any of the steps of examples 1-7; and memory coupled to the processor circuitry, the memory to store MN ID information.
Example 9 can include one or more non-transitory computer-readable media having stored thereon a sequence of instructions which, when executed, cause processor circuitry to: perform any of the steps of examples 1-7.
Example 10 can include an apparatus comprising: processing circuitry to: process a message to determine whether the message was broadcast by a management node (MN) of a subnetwork, determine an MN identifier (ID) based on whether the message was broadcast by the MN of the subnetwork, and store the MN ID in a list of candidate MNs; and memory coupled to the processing circuitry, the memory to store MN ID information.
Example 11 can include the apparatus of example 10, wherein the message comprises a system information block (SIB) message, a master information block (MIB) message, synchronization signal block (SSB) message, or a dedicated message.
Example 12 can include the apparatus of any of examples 10 or 11, wherein the message comprises an indication of MN subnetwork capabilities, and wherein the processor circuitry is further to: measure a reference signal received power (RSRP) associated with the message; and determine to connect with the subnetwork based on the RSRP, UE communication requirements, and UE computational requirements.
Example 13 can include the apparatus of any of examples 10-12, wherein the UE communication requirements comprise estimated rate, latency, and jitter, and wherein the UE computational requirements comprise functional offloading and capability extension.
Example 14 can include the apparatus of any of examples 10-13, wherein the message comprises an indication of subnetwork communication capabilities that include connection to overlay network capabilities, connection quality to overlay network quantified in round trip time (RTT) capabilities, subnetwork load capabilities, or number of component carriers (CCs) capabilities.
Example 15 can include the apparatus of any of examples 10-14, wherein the processor circuitry is further to: cause transmission of a connection request message to the MN to join the subnetwork.
Example 16 can include the apparatus of example 15, wherein the processing circuitry is further to: cause transmission of information for requirements on MN capabilities and subnetwork resources to the MN to join the subnetwork.
Example 17 can include the apparatus of example 15, wherein the connection request message is transmitted via a radio resource control (RRC) protocol message.
Example 18 can include the apparatus of any of examples 10-17, wherein the processor circuitry is further to: process a subnetwork connect response message from the MN; and cause transmission of a connection indication message to the MN based on the connect response message.
Example 19 can include the apparatus of any of examples 10-18, wherein the processor circuitry is further to: access a model for MN selection; provide the model with aggregated measurement and capabilities reports of the candidate MNs and a set of application requirements; receive an output from the model; and select the MN from the list of candidate MNs based on the output from the model.
Example 20 can include the apparatus of example 19, wherein the capabilities reports comprise a link quality report, a subnetwork communications capabilities report, or a subnetwork computational capabilities report.
Example 21 can include the apparatus of example 19, wherein the set of application requirements comprise application communication requirements and application computation requirements.
Example 22 can include the apparatus of example 19, wherein the output comprises a soft metric, wherein the MN is selected based on the soft metric.
Example 23 can include a method for performing any of the steps of examples 10-22.
Example 24 can include one or more non-transitory computer-readable media having stored thereon a sequence of instructions which, when executed, cause processor circuitry to: perform any of the steps of examples 10-22.
Example 25 can include one or more non-transitory computer-readable media having stored thereon a sequence of instructions which, when executed, cause processor circuitry to: connect with a subnetwork associated with a first management node (MN); process a first measurement configuration received from the first MN based on connecting with the subnetwork, the first measurement configuration associated with a second MN; and cause a collection of a second measurement configuration associated with the second MN based on processing the first measurement configuration.
Example 26 can include the one or more non-transitory computer-readable media of example 25, wherein the sequence of instructions, when executed, further cause the processing circuitry to: process a capability report received from the first MN, the capability report associated with the second MN.
Example 27 can include the one or more non-transitory computer-readable media of any of examples 25 or 26, wherein the sequence of instructions, when executed, further cause the processor circuitry to: cause a reselection process based on layer three measurements.
Example 28 can include the one or more non-transitory computer-readable media of any of examples 25-27, wherein the sequence of instructions, when executed, further cause the processor circuitry to: process a reselection order for selecting a different MN than the first MN; select the different MN for connection based on layer three measurements; and cause transmission of a reselection indication to the first MN.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing, by a management node (MN) of a subnetwork, a connection establishment request for a user equipment (UE) to join the subnetwork;
processing, by the MN, cryptographic information based on the connection establishment request; and
authenticating, by the MN, the UE based on the cryptographic information.

2. The method of claim 1, wherein the cryptographic information includes shared key information and the method further comprises:
obtaining the shared key information in a first pairing of the MN and the UE,
wherein the connection establishment request is associated with a second pairing of the MN and the UE that occurs after the first pairing.

3. The method of claim 1, wherein the cryptographic information is received via a discovery message exchange.

4. The method of claim 1, wherein processing the cryptographic information comprises:
generating a first subnetwork identifier (ID);
generating, using a cryptographic key shared with the UE, a first authentication token based on the first subnetwork ID;
causing transmission of the first authentication token to the UE; and
processing a second authentication token from the UE, wherein the second authentication token is generated based on transmitting the first authentication token to the UE and a second subnetwork ID, and wherein the cryptographic information comprises the first authentication token and the second authentication token.

5. The method of claim 1, wherein the MN and the UE are connected to a network, and wherein exchanging the cryptographic information is via a base station.

6. The method of claim 1, wherein exchanging cryptographic information subnetwork comprises:
processing a UE authentication token and a UE subnetwork ID;
causing transmission of the UE authentication token, a UE subnetwork ID, a UE global ID, and an MN subnetwork ID to a base station;
processing an authentication response from the base station, wherein the authentication response comprises a base station authentication token generated based on the UE global ID, wherein the cryptographic information comprises the UE authentication token.

7. The method of claim 1, wherein exchanging the cryptographic information comprises:
registering with a third-party application;
processing a UE authentication token and a UE subnetwork ID;
causing transmission of the UE authentication token, a UE subnetwork ID, a UE global ID, and an MN subnetwork identifier to the third-party application; and
processing an authentication response from the third-party application, wherein the authentication response comprises a third-party application authentication token generated based on the UE global ID, and wherein the cryptographic information comprises the UE authentication token.

8. An apparatus comprising:
processor circuitry to:
process a message to determine whether the message was broadcast by a management node (MN) of a subnetwork,
determine an MN identifier (ID) based on whether the message was broadcast by the MN of the subnetwork, and
store the MN ID in a list of candidate MNs; and
interface circuitry coupled to the processor circuitry.

9. The apparatus of claim 8, wherein the message comprises a system information block (SIB) message, a master information block (MIB) message, synchronization signal block (SSB) message, or a dedicated message.

10. The apparatus of claim 9, wherein the message comprises an indication of MN subnetwork capabilities, and wherein the processor circuitry is further to:
measure a reference signal received power (RSRP) associated with the message; and
determine to connect with the subnetwork based on the RSRP, UE communication requirements, and UE computational requirements.

11. The apparatus of claim 10, wherein the UE communication requirements comprise estimated rate, latency, and jitter, and wherein the UE computational requirements comprise functional offloading and capability extension.

12. The apparatus of claim 8, wherein the message comprises an indication of subnetwork communication capabilities that include connection to overlay network capabilities, connection quality to overlay network quantified in round trip time (RTT) capabilities, subnetwork load capabilities, or number of component carriers (CCs) capabilities.

13. The apparatus of claim 8, wherein the processor circuitry is further to:
cause transmission of a connection request message to the MN to join the subnetwork.

14. The apparatus of claim 13, wherein the processor circuitry is further to:
cause transmission of information for requirements on MN capabilities and subnetwork resources to the MN to join the subnetwork.

15. The apparatus of claim 13, wherein the connection request message is transmitted via a radio resource control (RRC) protocol message.

16. The apparatus of claim 8, wherein the processor circuitry is further to:
process a subnetwork connect response message from the MN; and
cause transmission of a connection indication message to the MN based on the connect response message.

17. The apparatus of claim 8, wherein the processor circuitry is further to:
access a model for MN selection;
provide the model with aggregated measurement and capabilities reports of the candidate MNs and a set of application requirements;
receive an output from the model; and
select the MN from the list of candidate MNs based on the output from the model.

18. The apparatus of claim 17, wherein the capabilities reports comprise a link quality report, a subnetwork communications capabilities report, or a subnetwork computational capabilities report.

19. One or more non-transitory computer-readable media having stored thereon a sequence of instructions which, when executed, cause processor circuitry to:
connect with a subnetwork associated with a first management node (MN);
process a first measurement configuration received from the first MN based on connecting with the subnetwork, the first measurement configuration associated with a second MN; and
cause a collection of a second measurement configuration associated with the second MN based on processing the first measurement configuration.

20. The one or more non-transitory computer-readable media of claim 19, wherein the sequence of instructions, when executed, further cause the processor circuitry to:
process a capability report received from the first MN, the capability report associated with the second MN.
